(19) United States
(12) Patent Application Publication
(10) Pub. No.: US 2015/0221924 A1
(43) Pub. Date: Aug. 6, 2015

(54) BATTERY MODULE

(71) Applicant: Samsung SDI Co., Ltd., Yongin-si (KR)

(72) Inventor: Ji-Ho Lee, Yongin-si (KR)

(21) Appl. No.: 14/606,980

(22) Filed: Jan. 27, 2015

(30) Foreign Application Priority Data
Feb. 4, 2014 (KR) 10-2014-0012376

(51) Int. Cl. H01M 2/20

(52) U.S. Cl. CPC H01M 2/206; H01M 2220/20

(57) ABSTRACT

A battery module includes a plurality of battery cells and a terminal connecting member. Each battery cell includes a fastening terminal portion, and the plurality of battery cells are aligned along one direction. The terminal connecting member couples fastening terminal portions of adjacent ones of the battery cells to each other. The terminal connecting member has first and second contact portions respectively contacting the fastening terminal portions of the adjacent ones of the battery cells, the first and second contact portions are inclined from a center of the terminal connecting member toward both sides of the terminal connecting member, and the fastening terminal portions correspond to the first and/or second contact portion.

### CROSS-REFERENCE TO RELATED APPLICATION

This application claims priority to and the benefit of Korean Patent Application No. 10-2014-0012376, filed on Feb. 4, 2014 in the Korean Intellectual Property Office, the entire contents of which are incorporated herein by reference.

### BACKGROUND

1. Field

An aspect of embodiments of the present invention relates to a battery module.

2. Description of the Related Art

As industries of electronics, communications, and the like are rapidly developed, the use of portable electronic devices, such as a camcorder, a cellular phone, and a notebook PC, has recently increased. Accordingly, the use of secondary batteries has also increased. Secondary batteries can be used not only in portable electronic devices but also in medium- and large-sized apparatuses, such as an electric tool, an automobile, a space transportation means, a motorbike, a motor scooter, and an aerial transportation means, which require high output and high power. The secondary batteries used in the medium- and large-sized apparatuses may be a large-capacity battery module or battery pack formed by coupling (e.g., connecting) a plurality of battery cells in series or parallel.

The battery module can include a plurality of battery cells, and the battery cells store energy to be transmitted to an external electronic device through an electrochemical reaction. The plurality of battery cells are joined (e.g., fixed) by a housing to be used as a single power source. The battery cells are electrically coupled (e.g., electrically connected) to each other by a bus-bar or the like. When the battery cells are not arranged (e.g., positioned) in parallel with each other or when a minute difference in height between the battery cells occurs, contact between terminal portions of the battery cells and the bus-bar may not be properly made, and therefore, a contact failure occurs. Accordingly, various studies have been conducted to more stably and efficiently maintain high current flowing between battery cells.

### SUMMARY

Embodiments of the present invention provide a battery module having a structure in which adjacent battery cells can be stably coupled to each other.

Embodiments of the present invention also provide a battery module including a terminal connecting member having first and second contact portions which are each formed to be inclined.

Embodiments of the present invention also provide a battery module having a fastening terminal portion which includes a terminal and a rivet.

Embodiments of the present invention also provide a battery module in which a terminal connecting member has an increased surface roughness so as to improve the safety and reliability of the battery module.

According to an embodiment of the present invention, there is provided a battery module including: a plurality of battery cells each including a fastening terminal portion, the plurality of battery cells being aligned along one direction; and a terminal connecting member coupling fastening terminal portions of adjacent ones of the battery cells, wherein the terminal connecting member has first and second contact portions respectively contacting the fastening terminal portions of the adjacent ones of the battery cells, the first and second contact portions are inclined from a center of the terminal connecting member toward both sides of the terminal connecting member, and the fastening terminal portions correspond to the first and/or second contact portion.

An inclination angle θ of the fastening terminal portion, the first contact portion, and/or the second contact portion may satisfy the following Expression 1:

θ≧tan⁻¹ (h/d)

(wherein h is a height difference between the first and second battery cells, and d is a distance between the respective fastening terminal portions of the adjacent ones of the battery cells).

The fastening terminal portion may include a terminal coupled to a respective one of the battery cells and a rivet coupled to the terminal.

The rivet may have an accommodating groove that corresponds to the terminal, and the terminal may be coupled to the rivet at the accommodating groove.

One side of the rivet may correspond to the first and/or second contact portion, and another side of the rivet may correspond to an upper surface of the terminal.

The other side of the rivet may be welded to the terminal.

A first fastening opening may extend through the terminal connecting member at the first and/or second fastening portion, and a second fastening opening may be in the rivet. The first and second fastening openings may extend vertically with respect to a surface of the battery cells, may be parallel to each other, and may be configured to accommodate a fastening member therein. A diameter of the first fastening opening may be greater than a diameter of the fastening member.

The rivet may include a conductive material.

The fastening terminal portion and the terminal connecting member may be coupled to each other by compression of the terminal connecting member in a direction toward the fastening terminal portion.

The first and/or second contact portion may have an increased surface roughness on a surface configured to contact the fastening terminal portion.

The surface roughness may be an embossing pattern.

The battery module may further include a housing accommodating the battery cells therein. The housing may include a pair of end plates adjacent to wide surfaces of outermost ones of the battery cells; a pair of side plates at opposite side surfaces of the battery cells, the side plates may couple the pair of end plates to each other; and a bottom plate at a bottom surface of the battery cells.

The pair of end plates, the pair of side plates and the bottom plate may be coupled to each other by bolts.

The first and second contact portions may mirror each other about the center of the terminal connecting member.

As described above, according to embodiments of the present invention, adjacent battery cells are stably coupled to each other, thereby improving the safety and reliability of the battery module.

Further, the first and second contact portions of the terminal connecting member are formed to be inclined, and the fastening terminal portions are respectively formed to correspond to the first and second contact portions, so that a contact failure caused by a difference in height between the battery cells is reduced or prevented, thereby improving the reliability and efficiency of the battery module.

Further, the fastening terminal portion may be configured with the terminal and the rivet, and thus, the shape of the terminal is not limited. Accordingly, it is possible to simplify a manufacturing process of the battery module and to reduce manufacturing cost.

Further, the first and second contact portions of the terminal connecting member have an increased surface roughness, so that it is possible to improve friction between the terminal connecting member and the fastening terminal portion, thereby improving the coupling between the terminal connecting member and the fastening terminal portion.

### BRIEF DESCRIPTION OF THE DRAWINGS

Example embodiments will now be described more fully hereinafter with reference to the accompanying drawings; however, the present invention may be embodied in different forms and should not be construed as limited to the embodiments set forth herein. Rather, these embodiments are provided so that this disclosure will be thorough and complete and will fully convey the scope of the example embodiments to those skilled in the art.

In the figures, dimensions may be exaggerated for clarity of illustration. It will be understood that when an element is referred to as being “between” two elements, it can be the only element between the two elements or one or more intervening elements may also be present. Like reference numerals refer to like elements throughout.

FIG. 1 is a perspective view of a battery module according to an embodiment of the present invention.

FIG. 2 is a partially exploded perspective view of the battery module shown in FIG. 1.

FIG. 3 is a partial perspective view of portion A of FIG. 1 according to the embodiment of the present invention.

FIG. 4A is a sectional view taken along line A-A′ of FIG. 3, and FIG. 4B is a sectional view showing a different orientation of the elements illustrated in FIG. 4A.

FIG. 5 is a schematic sectional view showing fastening terminal portions and a terminal connecting member of a battery module according to another embodiment of the present invention.

FIG. 6 is a schematic sectional view showing fastening terminal portions and a terminal connecting member of a battery module according to still another embodiment of the present invention.

FIG. 7 is a schematic sectional view showing fastening terminal portions and a terminal connecting member of a battery module according to still another embodiment of the present invention.

FIG. 8 is a perspective view showing a terminal connecting member of a battery module according to still another embodiment of the present invention.

### DETAILED DESCRIPTION

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements also therebetween. Also, when an element is referred to as being “connected to” or “coupled to” another element, it can be directly connected or coupled to the other element or be indirectly connected or coupled to the other element with one or more intervening elements also therebetween. Hereinafter, like reference numerals refer to like elements. Further, the use of “may” in describing embodiments of the present invention relates to “one or more embodiments of the present invention.”

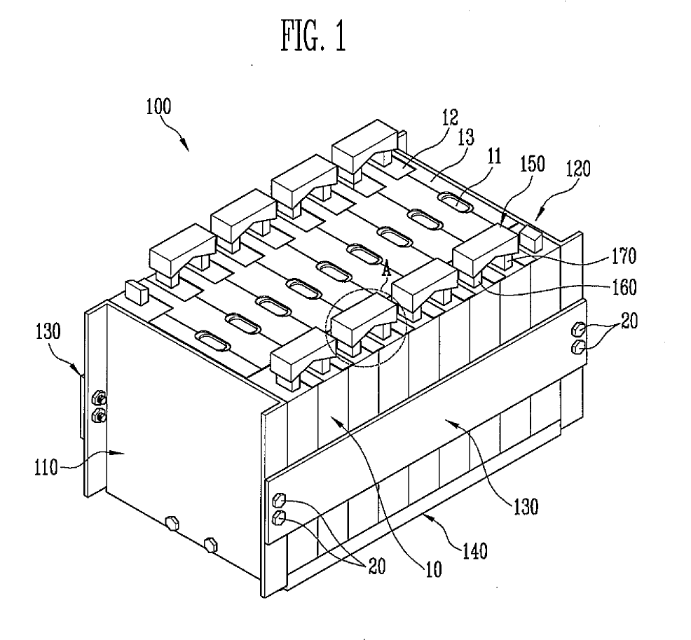

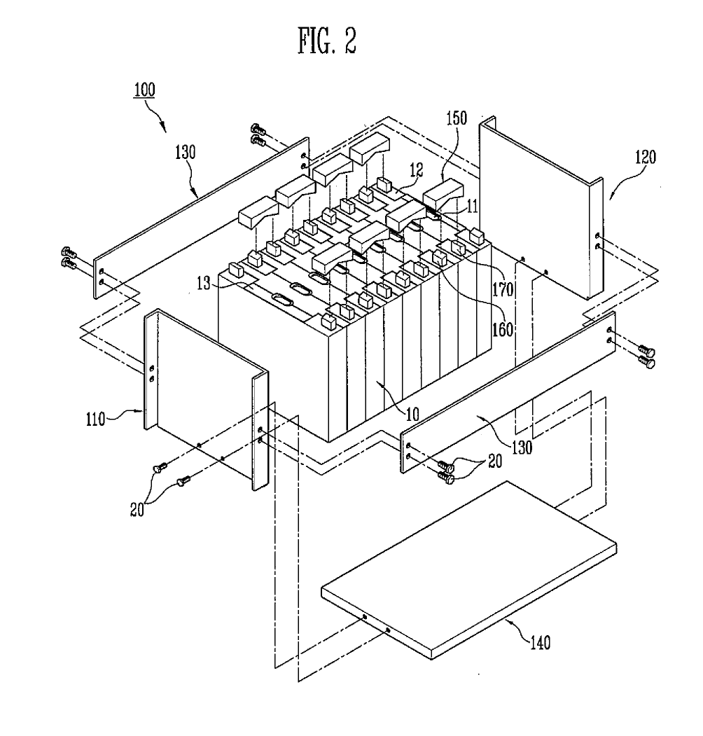

FIG. 1 is a perspective view of a battery module according to an embodiment of the present invention. FIG. 2 is an exploded perspective view of the battery module shown in FIG. 1.

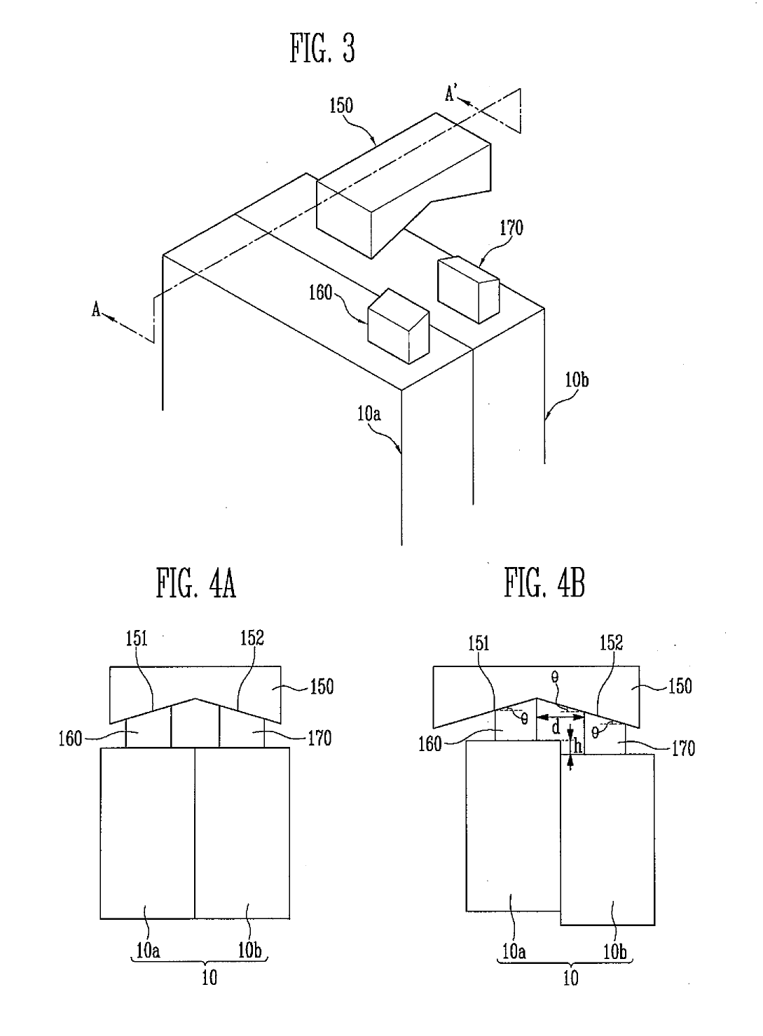

As shown in FIGS. 1 and 2, the battery module 100 according to this embodiment includes a plurality of battery cells 10 each configured to have fastening terminal portions 160 and 170 on one surface 12, the plurality of battery cells 10 being aligned along one direction; a terminal connecting member 150 configured to couple (e.g., connect) fastening terminal portions 160 and 170 of adjacent ones of the battery cells 10; and a housing 110, 120, 130, and 140 configured to accommodate the plurality of battery cells 10 therein. The terminal connecting member 150 has first and second contact portions 151 and 152 (see FIG. 4) respectively contacting the fastening terminal portions 160 and 170 of the adjacent battery cells 10. The first and second contact portions 151 and 152 may be formed to be inclined (e.g., inclined with respect to a surface of the terminal connecting member opposite to the first and second contact portions 151 and 152 or with respect to the one surface 12) from a center of the terminal connecting member 150 toward both sides of the terminal connecting member 150 (e.g., the first and second contact portions 151 and 152 may mirror each other about the center of the terminal connecting member 150). The fastening terminal portions 160 and 170 may be respectively formed having shapes corresponding to the first and/or second contact portions 151 and 152 (e.g., the fastening terminal portions 160 and 170 may be inclined to correspond to the first and second contact portions 151 and 152).

Each battery cell 10 may include a battery case having the one surface 12, an electrode assembly, and an electrolyte. The electrode assembly and the electrolyte are accommodated in the battery case. The electrode assembly and the electrolyte generate energy through an electrochemical reaction therebetween. The one surface 12 may be provided with the fastening terminal portions 160 and 170 (e.g., the fastening terminal portions 160 and 170 may extend from the one surface 12) electrically coupled to the electrode assembly and a vent 11 that is a passage through which excess gas generated inside the battery cell 10 may be exhausted. For example, the fastening terminal portions 160 and 170 may be positive and negative fastening terminals 160 and 170 having polarities different from each other. The fastening terminal portions 160 and 170 of battery cells 10 that are adjacent to each other may be electrically coupled to each other in series or parallel by the terminal connecting member 150 (e.g., the fastening terminal portion 160 of one battery cell 10 may be electrically coupled to the fastening terminal portion 170 of an adjacent battery cell 10). In addition, a gasket 13 made of an electrically insulating material may be provided on the one surface 12 of the battery cells 10. The fastening terminal portions 160 and 170 are protruded to the outside of (e.g., protrude through) the gasket 13.

The plurality of battery cells 10 may be aligned along one direction so that wide surfaces of the battery cells 10 face each other. The plurality of aligned battery cells 10 may be fixed (e.g., joined together) by the housing 110, 120, 130, and 140. The housing 110, 120, 130, and 140 may include a pair of end plates 110 and 120 configured to face the wide surfaces of outermost battery cells 10 and side and bottom plates 130 and 140 configured to couple the pair of end plates 110 and 120 to each other. The side plates 130 may be at (e.g., may support) opposite side surfaces of the battery cells 10, and the bottom plate 140 may be at (e.g., may support) a bottom surface of the battery cells 10. The pair of end plates 110 and 120, the side plates 130, and the bottom plate 140 may be coupled to each other by connecting members, such as bolts 20.

FIG. 3 is a partial perspective view of portion A of FIG. 1 according to the embodiment of the present invention. FIG. 4A is a sectional view taken along the line A-A′ of FIG. 3, and FIG. 4B is a sectional view illustrating a different arrangement of the elements shown in FIG. 4A.

As shown in FIGS. 3 and 4, the terminal connecting member 150 according to this embodiment has first and second contact portions 151 and 152 respectively contacting the fastening terminal portions 160 of a first battery cell 10a and the fastening terminal portion 170 of a second battery cell 10b. The first and second contact portions 151 and 152 may be formed to be inclined from the center of the terminal connecting member 150 toward both sides of the terminal connecting member 150.

Although it has been illustrated in FIGS. 3 and 4 that the first and second contact portions 151 and 152 are formed to be inclined in lower diagonal directions (e.g., inclined toward the first and second battery cells 10a and 10b), the present invention is not limited thereto. In other words, the first and second contact portions 151 and 152 may be formed to be inclined in upper diagonal directions (e.g., inclined away from the first and second battery cells 10a and 10b). In embodiments of the present invention, the first and second contact portions 151 and 152 may be formed having various shapes. Hereinafter, the terminal connecting member 150 having the first and second contact portions 151 and 152 formed to be inclined in the lower diagonal directions will be primarily described.

The fastening terminal portions 160 and 170 may be made of aluminum, copper, or the like, and the terminal connecting member 150 may be made of a conductive material, such as aluminum. The battery cells 10 according to this embodiment generate high current, and the fastening terminal portions 160 and 170 and the terminal connecting member 150 may be provided to have sufficient strength so that the high current stably flows therein.

Adjacent battery cells 10 may be referred to as the first battery cell 10a and the second battery cell 10b, and the fastening terminal portion 160 of the first battery cell 10a may be electrically coupled to the fastening terminal portion 170 of the second battery cell 10b by the terminal connecting member 150. The fastening terminal portions 160 and 170 of the first and second battery cells 10a and 10b are respectively formed having shapes corresponding to the first and second contact portions 151 and 152. The fastening terminal portions 160 and 170 of the first and second battery cells 10a and 10b may be respectively coupled to the first and second contact portions 151 and 152 and be in surface contact with the first and second contact portions 151 and 152 due to a pressure applied to (e.g., pressing) the terminal connecting member 150 in a direction toward the fastening terminal portions 160 and 170.

The inclination angle of the first or second contact portion 151 or 152 of the terminal connecting member 150 may satisfy the following Expression 1 wherein h is a height difference between the first and second battery cells 10a and 10b, and d is a distance between the fastening terminal portion 160 the first battery cell 10a and the fastening terminal portion 170 of the second battery cell 10b.

θ≧tan⁻¹(h/d) Expression 1:

Accordingly, h and d may satisfy Expression 2 or 3.

h≦d×tan θ Expression 2:

d≧h/tan θ Expression 3:

Thus, the fastening terminal portions 160 and 170 respectively formed having shapes corresponding to the first and second contact portions 151 and 152 can satisfy any of Expressions 1 to 3.

As described above, the fastening terminal portions 160 and 170 can respectively be in surface contact with the first and second contact portions 151 and 152 having the inclination angle θ which satisfies Expression 1. When a step difference (e.g., a height difference) between the fastening terminal portions 160 and 170 occurs due to the step difference (e.g., the height difference) between the first and second battery cells 10a and 10b and a thickness of the battery cells, the first and second contact portions 151 and 152 can be respectively coupled to the fastening terminal portions 160 and 170 through only the movement (e.g., lateral movement) of the terminal connecting member 150 so that current can efficiently and reliably flow between the first and second battery cells 10a and 10b.

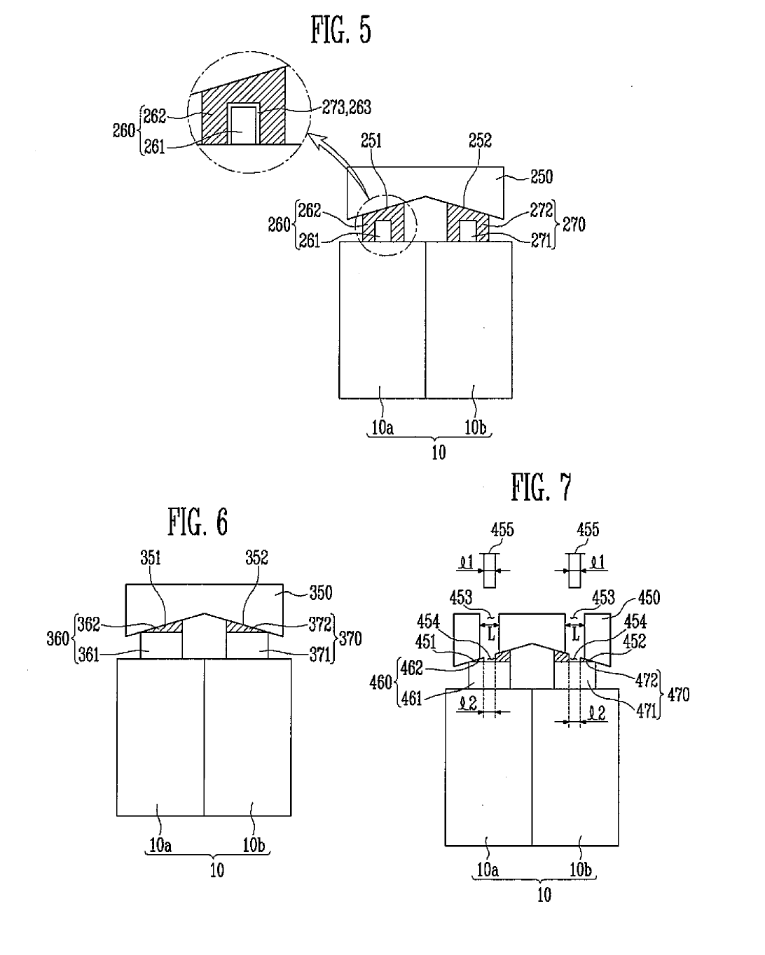

FIG. 5 is a schematic sectional view showing fastening terminal portions and a terminal connecting member of a battery module according to another embodiment of the present invention.

As shown in FIG. 5, in the battery module according to this embodiment, a terminal connecting member 250 may be coupled to fastening terminal portions 260 and 270 respectively provided on one surface of the first and second battery cells 10a and 10b that are adjacent to each other. The terminal connecting member 250 has first and second contact portions 251 and 252 respectively contacting the fastening terminal portions 260 and 270. The first and second contact portions 251 and 252 may be formed to be inclined from a center of the terminal connecting member 250 toward both sides of the terminal connecting member 250.

The fastening terminal portions 260 and 270 of the first and second battery cells 10a and 10b, respectively include terminals 261 and 271 and rivets 262 and 272. One side (e.g., a top side or surface) of the rivets 262 and 272 may be respectively formed having a shape corresponding to the first and second contact portions 251 and 252 (e.g., when the first and second contact portions 251 and 252 mirror each other, the rivets 262 and 272 may have one shape that corresponds to one of the first or second contact portions 251 and 252 and be rotated 180° to correspond to the other of the first or second contact portions 251 or 252), and the other side (e.g., a bottom side or surface) of the rivets 262 and 272 may respectively have an accommodating groove 263 and 273 corresponding to the terminals 261 and 271. The terminals 261 and 271 may be respectively coupled to (e.g., coupled to an inner surface of) the rivets 262 and 272 by being inserted (e.g., inserted by a force) into the accommodating grooves 263 and 273. The shapes of the terminals are not limited, and hence, existing terminals can be used as they are. Thus, an additional process is not required, thereby reducing manufacturing cost.

FIG. 6 is a schematic sectional view showing fastening terminal portions and a terminal connecting member of a battery module according to still another embodiment of the present invention.

As shown in FIG. 6, a terminal connecting member 350 according to this embodiment may be coupled to fastening terminal portions 360 and 370 respectively provided on one surface of the first and second battery cells 10a and 10b that are adjacent to each other. The terminal connecting member 350 has first and second contact portions 351 and 352 respectively contacting the fastening terminal portions 360 and 370. The first and second contact portions 351 and 352 may be formed to be inclined from a center of the terminal connecting member 350 toward both sides of the terminal connecting member 350.

The fastening terminal portions 360 and 370 of the first and second battery cells 10a and 10b respectively include terminals 361 and 371 and rivets 362 and 372. One side (e.g., a top side or surface) of the rivets 362 and 372 may be respectively formed have a shape corresponding to the first and second contact portions 351 and 352, and the other side (e.g., a bottom side or surface) of the rivets 362 and 372 may be respectively formed having a shape corresponding to a surface of the terminals 361 and 371.

The rivets 362 and 372 may be respectively located (e.g., positioned) between the first and second contact portions 351 and 352 and the terminals 361 and 371, and a separate process may be utilized so as to improve the coupling (e.g., coupling strength) between the other side of the rivets 362 and 372 and the terminals 361 and 371. For example, the rivets 362 and 372 may be coupled to the terminals 361 and 371 through welding.

The terminals 361 and 371, for example, may include a positive electrode terminal 361 made of aluminum and a negative electrode terminal 371 made of copper. The rivets 362 and 372 may include a conductive material, such as aluminum. A laser beam may be provided to the positive and negative electrode terminals 361 and 371, and accordingly, interfaces between the rivets 362 and 372 and the respective positive and negative electrode terminals 361 and 371 may be melted, so that the rivets 362 and 372 can be stably adhered to the respective positive and negative electrode terminals 361 and 371.

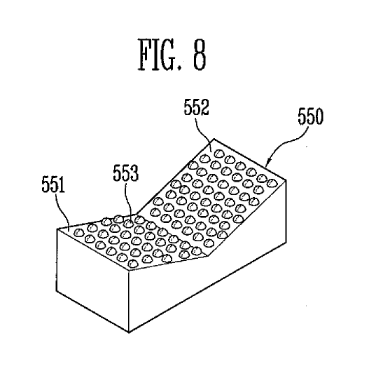

FIG. 7 is a schematic sectional view showing fastening terminal portions and a terminal connecting member of a battery module according to still another embodiment of the present invention.

As shown in FIG. 7, a terminal connecting member 450 in this embodiment may be coupled to fastening terminal portions 460 and 470 respectively provided on one surface (e.g., a top side or surface) of the first and second battery cells 10a and 10b that are adjacent to each other. The terminal connecting member 450 has first and second contact portions 451 and 452 respectively contacting the fastening terminal portions 460 and 470. The first and second contact portions 451 and 452 may be formed to be inclined from a center of the terminal connecting member 450 toward both sides of the terminal connecting member 450.

The fastening terminal portions 460 and 470 of the first and second battery cells 10a and 10b respectively include terminals 461 and 471 and rivets 462 and 472. One side (e.g., a top side or surface) of the rivets 462 and 472 may be respectively formed having a shape corresponding to the first and second contact portions 451 and 452, and the other side (e.g., a bottom side or surface) of the rivets 462 and 472 may be respectively formed having a shape corresponding to one surface (e.g., a top surface) of the terminals 461 and 471.

First and second fastening openings 453 and 454 (e.g., fastening holes) are respectively formed through (e.g., formed to extend through) the terminal connecting member 450 at each of the first and second contact portions 451 and 452 and the rivets 462 and 472. The first and second fastening openings 453 and 454 are vertically positioned along the same line (e.g., the first and second fastening openings 453 and 454 extend parallel to each other). In this embodiment, a fastening member 455 is inserted into each of the first and second fastening openings 453 and 454, so that each of the fastening terminal portions 460 and 470 can be coupled to (e.g., fastened to) the terminal connecting member 450.

The diameter L of the first fastening opening 453 may be formed greater than a diameter l₁ of the fastening member 455, and a diameter l₂ of the second fastening opening 454 may be formed equal to the diameter l₁ of the fastening member 455.

The diameter L of the first fastening opening 453 is formed greater than the diameter l₁ or l₂ of the fastening member 455 or the second fastening opening 454, so that the terminal connecting member 450 can freely move in the horizontal direction. Accordingly, it is possible to easily overcome a step difference (e.g., a height difference) between the first and second battery cells 10a and 10b.

FIG. 8 is a perspective view showing a terminal connecting member of a battery module according to still another embodiment of the present invention.

As shown in FIG. 8, a terminal connecting member 550 may have first and second contact portions 551 and 552 respectively configured to be in surface contact with fastening terminal portions. In this embodiment, the first and second contact portions 551 and 552 may be formed to be inclined from a center of the terminal connecting member 550 toward both sides of the terminal connecting member 550. For example, the first and second contact portions 551 and 552 may each have a surface roughness 553 (e.g., may each have an increased surface roughness).

The surface roughnesses 553 may be formed as embossing patterns on the first and second contact portions 551 and 552.

The surface roughnesses 553 improve friction between the terminal connecting member 550 and the fastening terminal portions, thereby improving the coupling (e.g., the coupling strength) between the terminal connecting member and the fastening terminal portions.

Example embodiments of the present invention have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims and their equivalents.

What is claimed is:

1. A battery module comprising:
a plurality of battery cells each comprising a fastening terminal portion, the plurality of battery cells being aligned along one direction; and
a terminal connecting member coupling fastening terminal portions of adjacent ones of the battery cells to each other,
wherein the terminal connecting member has first and second contact portions respectively contacting the fastening terminal portions of the adjacent ones of the battery cells,
wherein the first and second contact portions are inclined from a center of the terminal connecting member toward both sides of the terminal connecting member, and
wherein the fastening terminal portions correspond to the first and/or second contact portion.

2. The battery module of claim 1, wherein an inclination angle θ of the fastening terminal portion, the first contact portion, and/or the second contact portion satisfies the following Expression 1:
θ≧tan⁻¹(h/d)Expression 1
(wherein h is a height difference between the adjacent ones of the battery cells, and d is a distance between the respective fastening terminal portions of the adjacent ones of the battery cells).

3. The battery module of claim 1, wherein the fastening terminal portion comprises a terminal coupled to a respective one of the battery cells and a rivet coupled to the terminal.

4. The battery module of claim 3, wherein the rivet has an accommodating groove that corresponds to the terminal, and the terminal is coupled to the rivet at the accommodating groove.

5. The battery module of claim 3, wherein one side of the rivet corresponds to the first and/or second contact portion, and another side of the rivet corresponds to an upper surface of the terminal.

6. The battery module of claim 5, wherein the other side of the rivet is welded to the terminal.

7. The battery module of claim 5, wherein a first fastening opening extends through the terminal connecting member at the first and/or second contact portion, and a second fastening opening is in the rivet,
wherein the first and second fastening openings extend vertically with respect to a surface of the battery cells, are parallel to each other, and are configured to accommodate a fastening member therein, and
wherein a diameter of the first fastening opening is greater than a diameter of the fastening member.

8. The battery module of claim 3, wherein the rivet comprises a conductive material.

9. The battery module of claim 1, wherein the fastening terminal portion and the terminal connecting member are coupled to each other by compression of the terminal connecting member in a direction toward the fastening terminal portion.

10. The battery module of claim 1, wherein the first and/or second contact portion has an increased surface roughness on a surface configured to contact the fastening terminal portion.

11. The battery module of claim 10, wherein the surface roughness is an embossing pattern.

12. The battery module of claim 1, further comprising a housing accommodating the battery cells therein,
wherein the housing comprises:
a pair of end plates adjacent to wide surfaces of outermost ones of the battery cells;
a pair of side plates at opposite side surfaces of the battery cells, the side plates coupling the pair of end plates to each other; and
a bottom plate at a bottom surface of the battery cells.

13. The battery module of claim 12, wherein the pair of end plates, the pair of side plates, and the bottom plate are coupled to each other by bolts.

14. The battery module of claim 1, wherein the first and second contact portions mirror each other about the center of the terminal connecting member.
